(19) United States
(12) Patent Application Publication
(10) Pub. No.: US 2023/0411672 A1
(43) Pub. Date: Dec. 21, 2023

(54) Electric Energy Store

(71) Applicant: Bayerische Motoren Werke Aktiengesellschaft, Muenchen (DE)

(72) Inventors: Dave ANDRE, Moosburg (DE); Torsten FRANKE, Muenchen (DE)

(21) Appl. No.: 18/030,789

(22) PCT Filed: Aug. 26, 2021
(86) PCT No.: PCT/EP2021/073558

§ 371 Date: Apr. 7, 2023

(30) Foreign Application Priority Data
Oct. 8, 2020 (DE) 10 2020 126 424.0

(51) Int. Cl. H01M 10/0525; H01M 10/613; H01M 10/625; H01M 10/6556; H01M 10/6567; H01M 50/242; H01M 50/249

(52) U.S. Cl. CPC H01M 10/0525; H01M 10/613; H01M 10/625; H01M 2220/20; H01M 10/6567; H01M 50/242; H01M 50/249; H01M 10/6556

(57) ABSTRACT

An electric energy store for installing into a motor vehicle includes at least two housing parts. A first housing part is not designed to receive storage cells and a second housing part is designed to receive all of the storage cells. The first housing part is designed to be installed in the motor vehicle as an upper housing part, and the second housing part is designed to be installed in the motor vehicle as a lower housing part. The first housing part can be closed by a removable first cover, and the second housing part is designed as a closed capsule with a non-removable second cover.

### BACKGROUND AND SUMMARY OF THE INVENTION

The invention relates to an electric energy store for motor vehicles, in particular to a lithium-ion store, and to a method for constructing a lithium-ion store for use in vehicles, such as those known, for example, as vehicle electrical system batteries, high-voltage stores or traction batteries. In the following, the electric energy store, in particular lithium-ion store, will be referred to in short as an energy store.

Known from DE 10 2019 110 007 B4, for example, is an energy store (in the form of a lithium-ion store) that has a storage installation space having two horizontally separated compartments (or housing parts), in which the horizontal dividing wall is embodied as a cooling plate, in which, in the lower installation space, the cell array is connected to the cooling plate in a suspended manner and with good thermal conductivity, and in which the cell contacting and the hazard opening of each cell are directed downward.

At the Tesla “Battery Day” on 22.09.2020 (live recording at https://www.youtube.com/embed/16T9xleZTds), an energy store (in the form of a lithium-ion store) was presented, which is an expendable store that has a high degree of rigidity due to a fixed cell bonding to the housing, but whose cell array cannot be repaired in the event of a fault.

It is the object of the invention to further improve an energy store for motor vehicles, and in particular a lithium-ion store for motor vehicles, as cost-effectively as possible.

This object is achieved by the features of the claimed invention.

The invention relates to an electric energy store for installing in a motor vehicle, composed of at least two housing parts,
wherein a first housing part is not designed to receive storage cells, and a second housing part is designed to receive all storage cells,
wherein the first housing part is designed to be installed in the motor vehicle as an upper housing part, and the second housing part is designed to be installed in the motor vehicle as a lower housing part,
wherein the first housing part can be closed by a removable first cover, and
wherein the second housing part is realized as a closed capsule, due to a non-removable second cover.

In an advantageous design of the invention, arranged between the two housing parts there is a housing middle part that separates the two housing parts horizontally and contains an interspace for a cooling fluid flowing through.

In a further advantageous design of the invention, the first housing part is designed to receive the storage electronics and has outwardly projecting electrical connections.

In a further advantageous design of the invention, the storage electronics of the first housing part and the storage cells of the second housing part are electrically connected to an electrical contacting, e.g. a cable harness, of which leadthrough(s) through the housing middle part is (are) provided with seal(s).

In a further advantageous design of the invention, the seal is designed to be burst-pressure resistant.

In a further advantageous design of the invention, the second housing part contains a cell pack comprising the storage cells, the housings of which are aligned vertically when in the installed state, and a frame arranged beneath the cell pack.

In a further advantageous design of the invention, the (when in the installed state) downwardly directed frame comprises a framework of support elements that act as force-absorbing housing extensions of the cells.

In a further advantageous design of the invention, the support elements are realized either as a separate support beneath a cell housing or as an extension of the cell housing or as a support tube completely enclosing the cell(s) and additionally comprising a cavity.

In a further advantageous design of the invention, the second cover has at least one area of material thinning that acts as a predetermined rupture point in the event of a critical gauge pressure in the store.

In a further advantageous design of the invention, the cell pack is protected from damage in the event of lateral and longitudinal crash by an interspace, between it and the outer boundaries of the second housing part, which is at least partially reinforced by plasto-elastic material filling the interspaces.

The invention is based on the following considerations:

The invention is intended to contribute to the reduction of the cost of the energy store (e.g. in the form of a lithium-ion store, also frequently abbreviated to “LiB”). Based on the generally already known prior art, an energy store is proposed that, over and above this known prior art, has the following properties:
crash- and bollard-proof,
hermetically sealed cell installation space,
self-extinguishing at cell level (i.e., propagation stop at cell level), and
storage electronics can be cooled, maintained and replaced.

The disadvantage of the generally known technology is that an energy store requires very high expenditures for the functions of crash and bollard safety, for protection against humidity and against thermal propagation, as well as for the reliability and hazard resistance of the electronic components. The solution of these problems is subject-matter of embodiments of the invention.

The energy store according to embodiments of the invention is divided into an electronics installation space that faces toward the vehicle interior, and a hermetically sealed cell installation space that faces toward the vehicle exterior. Due to the hermetic sealing of the cell installation space, seals and devices for degassing and/or condensate removal can be dispensed with. Furthermore, moisture load and corrosion of elements of the cell pack are precluded and, in the event of a hazard, penetration of cell discharge into the vehicle interior is prevented. The hermetically sealed connection imparts a high degree of stiffness to the arrangement. The excess-pressure relief function is effected by predetermined rupture points in the wall of the cell installation space in the vehicle exterior. The protection of the cell pack in lateral and longitudinal crash is reinforced by force-distributing plasto-elastic material. The plasto-elastic material quasi-hydraulically directs the intrusion forces laterally around the cell pack, or between the cells, with the result that, on the one hand, more material can be involved in crash absorption and, on the other hand, the forces are at least partially converted from compressive to tensile forces and in this form are applied to the wall of the cell installation space, resulting in an improved utilization of material. In addition, the quasi-hydraulic force distribution results in pressure being applied to the cells evenly from all sides, reducing the risk of cell damage due to a crash. At the same time, the plasto-elastic material can have intumescent properties to support propagation arrest at cell level. The protection of the cell pack in the event of a bollard crash is effected by a transmission of force from the wall of the cell installation space that faces toward the roadway, via an intermediate element in the region of the cell contacting, between the cells, or onto the cell wall, and through this onto the wall of the cell installation space that faces toward the vehicle interior, which assumes the transmission of force to the body structure of the vehicle and also includes the cooling function for the cells. By singulating the degassing spaces of the individual cells, the intermediate element also reduces the effect of a cell hazard thereby increases protection against thermal propagation. The separation of the electronics installation space from the cell installation space protects the electronics in the event of a battery hazard and ensures that they continue to function. The arrangement of the electronics installation space on the inside of the vehicle enables protection against moisture, increased temperature and high mechanical stress by devices commonly used in vehicle construction, for example for infotainment electronics. Furthermore, the electronic components can be serviced without opening the cell installation space. The dividing wall between the two installation spaces serves to cool the cell pack and the electronics.

An exemplary embodiment of the invention is represented in the drawings.

### BRIEF DESCRIPTION OF THE DRAWINGS

FIG. 1 shows an advantageous overall arrangement of the energy store according to an embodiment of the invention.

FIG. 2a shows a possible first design of the support elements forming the frame according to an embodiment of the invention.

FIG. 2b shows a possible second design of the support elements forming the frame according to an embodiment of the invention.

FIG. 3 shows an example of a method of production for this energy storage arrangement.

### DETAILED DESCRIPTION OF THE DRAWINGS

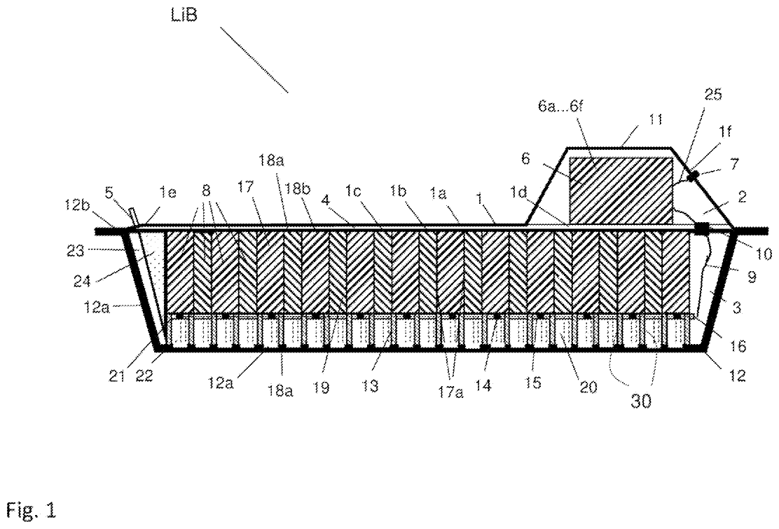

Represented in FIG. 1 is an energy store LiB, composed of a housing middle part 1, which horizontally separates two housing parts 2 and 3 of the energy store LiB and contains an interspace for a flowing cooling fluid 4, which can be connected by terminals 5 to an external cooling circuit. The first housing part 2 is directed toward the interior of the vehicle (i.e. upward when in the installed state), preferably serves to receive the storage electronics 6 and has outwardly directed electrical connections 7. The second housing part 3 is directed toward the exterior of the vehicle (i.e. downward towards the roadway when in the installed state) and serves to receive the storage cells 17 (also referred to in short as cells), which are designed in particular as a cell pack 8. The cells 17 may be, for example, round cells or prismatic cells. The storage electronics 6 and the cell pack 8 are electrically connected, for example, by way of an electrical contacting 9, the leadthrough of which, through the housing middle part 1, is preferably provided with a hermetic burst-pressure resistant seal 10. The first housing part 2 is provided with a sealed and repeatedly removable cover 11 attached to the housing middle part 1 to enable servicing of the electronic components.

The second housing part 3 is provided with a cover 12 that is hermetically sealed, e.g. welded, mortared or glued, so as to be non-removable from the housing middle part 1. In other words, the second housing part 3 is realized as a closed capsule by the housing middle part 1 and by the non-removable cover 12.

Preferably, the housing middle part 1 is composed of two deep-drawn, stamped plates 1a and 1b that are, for example, welded together, having flat sections 1c and 1d that provide the heat contact surfaces for the storage electronics 6 and the cell pack 8. The first plate 1a has openings 1e and if for the attachment of the terminals 5 and the connections 7, as well as a flange for the attachment of the first cover 11. The second plate 1b comprises a flange, or edge, for the attachment of the second cover 12. 1a, 1b, 12 in this case may be made of metal, plastic, or a multilayer plastic-metal composite, and can be at least partially provided with electrical insulation, e.g. foil.

The cell pack 8 is preferably composed of a (in the installed state) downwardly directed frame 13, cell contactings 14, terminals for the cell sensing device 15, electrical terminals 16 for the cell pack side of the electrical contacting 9, the cells 17, a bonding, or filler 19, between the cells 17, as well as a soft encapsulation 20 around the cell contactings 14 and the cell sensing device 15. The filler 19 in this case may be of the same material as the soft encapsulation 20 and be introduced together with the latter. In a preferred embodiment, these are composed of a hard paraffin. The cell contactings 14, the cell sensing device 15 and the terminals 16 in this case are at least partially preassembled in the frame 13 and form an ensemble 21 that, in a first alternative 18a, can be firmly connected to the second cover 12 and the housing middle part 1 or, in a second alternative 18b, to the cells 17 and the housing middle part 1. The connection in this case may be effected, for example, by an application adhesive or by double-sided adhesive foils, preferably with good thermal conductivity, or by a pre-application to one of the elements to be connected or by a weld.

Furthermore, a carrier 21 is provided, which serves to position the cells 17. The carrier 21 may in a known manner have, for example, spikes in the interspaces between the storage cells 17 if the latter are designed as round cells.

The frame 13 may be designed as part of the carrier 21, and also serves as a force-transmitting element from the second cover 12 to the housing middle part 1, or onto the cell wall 17a, for transmitting forces from bollard crashes to the housing middle part 1, and as a partition between the degassing spaces 22 assigned to the individual cells 17, for directing gases and particles ejected from cells 17 in the event of a hazard and protecting adjacent cells 17.

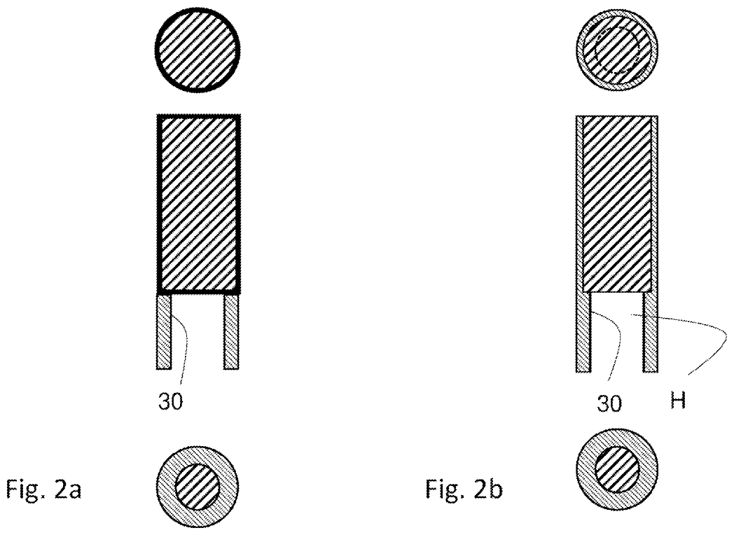

In a particularly advantageous design of the invention, the frame 13 comprises a framework of support elements 30, which act as force-absorbing housing extensions of the cells 17. A support element 30 in this case may be designed either as a separate support beneath a cell housing (FIG. 2a) or as an extension of the cell housing or as a support tube (FIG. 2b) completely enclosing the cell and additionally having a cavity H. The support elements 30 preferably have integrated electrical connections for forming the cell contactings 14 and/or the terminals for the cell sensing device 15 and/or the electrical terminals 16 for the cell pack side of the electrical contacting 9. Furthermore, the support elements 30 may be parts of the carrier 21.

The second cover 12 has at least one area of material thinning 12a that acts as a predetermined rupture point in the event of a critical gauge pressure in the store and limits the gauge pressure in a controlled manner. Preferably, a plurality of material thinnings 12a are realized on the front, rear and/or bottom side of the second cover 12. In a further embodiment, one material thinning 12a is located beneath each degassing space 22. In another embodiment, the predetermined rupture point is represented by local weakening of the hermetically sealed connection 12b between the housing middle part 1 and the second cover 12.

The cell pack 8 is preferably also protected from damage in the event of lateral and longitudinal crash by an interspace 23 between it and the outer boundaries of the second housing part 3. In a preferred embodiment, this protection is at least partially reinforced by plasto-elastic material 24 filling the interspaces 23, spreading locally acting forces over a larger area and hydraulically redirecting the direction of the force, and thereby including the entire storage composite in the absorption of the crash energy. In one possible embodiment, the plasto-elastic material 24 is composed of a low compressibility lightweight plastic granule, mineral filler, sand, cork, sawdust, wax, fluid, or a combination thereof, that fills the interspaces 23. In an advantageous embodiment, the plasto-elastic material has intumescent properties. The plasto-elastic material 24 in this case may be packaged in tubes or the like. In a further embodiment, the plasto-elastic material 24 is composed of preformed profiles. In a further embodiment, bonding, or filler, material 19 and plasto-elastic material 24 and possibly soft encapsulation 20 are composed of the same material and are introduced in a common production step.

The storage electronics 6 preferably include the cell monitoring device 6a, the protective switching device 6b, the battery management system 6c and, optionally, converters 6d for supplying further voltage levels in the vehicle, converters 6e for connecting external vehicle supply voltages and switching devices, fuse devices as well as filters 6f for electric power consumers of the vehicle. The elements of the storage electronics 6 are at least partially connected to the cell pack 8 via the electronics side of the electrical contacting 9 and to the connections 7 by way of further electrical connections 25. In an advantageous embodiment, the connections 7 and the further connections 25 are combined in one component, e.g. pigtail.

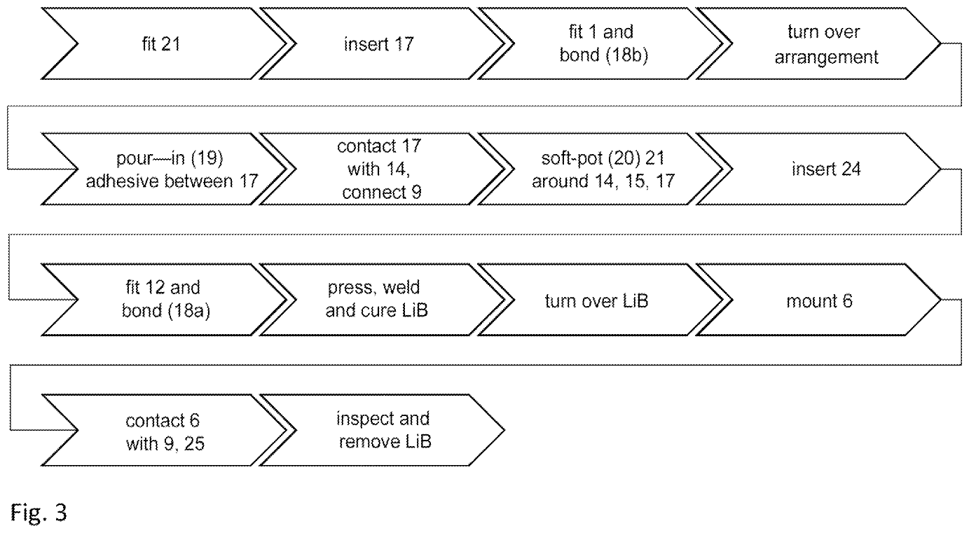

Shown schematically in FIG. 3 are advantageous steps for the construction of the energy store LiB according to an embodiment of the invention:
1. The carrier 21, with the frame 13, is fitted.
2. The cells 17 are inserted.
3. The housing middle part 1 is fitted and bonded.
4. The arrangement thus far is turned over.
5. The bonding 19 is applied by pouring-in an adhesive between the cells 17.
6. The cells 17 are provided with the cell contactings 14, and the electrical contacting 9 is connected.
7. The carrier 21 is potted, enclosing the cells 17 with the cell contactings 14 and the cell sensing device 15.
8. Plasto-elastic material 24 is introduced into the at least one interspace 23.
9. The second cover 12 is fitted and non-detachably connected (e.g. bonded) to the housing middle part 1.
10. The energy store LiB, with all aforementioned parts except the first cover 11, is cured after being bonded, welded or otherwise connected.
11. The energy store is turned over.
12. The storage electronics 6 are mounted.
13. The storage electronics 6 and the electrical connections 25 are connected to the electrical contacting 9.
14. The detachable cover 11 is closed, and the resulting overall assembly of the energy store LiB is inspected and removed for installation in the motor vehicle.

1.-10. (canceled)

11. An electric energy store for installing in a motor vehicle, the electric energy store comprising:
a first housing part; and
a second housing part, wherein:
the first housing part is not configured to receive storage cells, and the second housing part is configured to receive storage cells,
the first housing part is configured to be installed in the motor vehicle as an upper housing part, and the second housing part is configured to be installed in the motor vehicle as a lower housing part,
the first housing part is closable by a removable first cover, and
the second housing part is realized as a closed capsule, due to a non-removable second cover.

12. The electric energy store according to claim 11, wherein a housing middle part is arranged between the two housing parts, and the housing middle part separates the two housing parts horizontally and contains an interspace for a cooling fluid flowing through.

13. The electric energy store according to claim 11, wherein the first housing part is configured to receive storage electronics and has outwardly projecting electrical connections.

14. The electric energy store according to claim 12, wherein storage electronics of the first housing part and the storage cells of the second housing part are electrically connected to an electrical contacting, of which a leadthrough through the housing middle part is provided with a seal.

15. The electric energy store according to claim 14, wherein the seal is configured to be burst-pressure resistant.

16. The electric energy store according to claim 11, wherein the second housing part contains a cell pack comprising the storage cells, the housings of which are aligned vertically when in an installed state, and a frame arranged beneath the cell pack.

17. The electric energy store according to claim 16, wherein the frame is downwardly directed and comprises a framework of support elements that act as force-absorbing housing extensions of the storage cells.

18. The electric energy store according to claim 17, wherein the support elements are realized as a separate support beneath a cell housing, as an extension of the cell housing, or as a support tube completely enclosing one of the storage cells and additionally comprising a cavity.

19. The electric energy store according to claim 11, wherein the second cover has at least one area of material thinning that acts as a predetermined rupture point in an event of a critical gauge pressure in the electrical energy store.

20. The electric energy store according to claim 16, wherein the cell pack is protected from damage in an event of lateral and longitudinal crash by an interspace, between the cell pack and outer boundaries of the second housing part, which protection is at least partially reinforced by plasto-elastic material filling the interspaces.
